(19) United States
(12) Patent Application Publication
(10) Pub. No.: US 2002/0107773 A1
(43) Pub. Date: Aug. 8, 2002

(54) Method and apparatus for providing an electronic commerce environment for leveraging orders from a plurality of customers

(76) Inventor: Hamed M Abdou, Princeton, NJ (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 09/734,150

(22) Filed: Dec. 11, 2000

Related U.S. Application Data
(60) Provisional application No. 60/191,938, filed on Mar. 24, 2000.

(51) Int. Cl. G06F 17/60

(52) U.S. Cl. 705/37

(57) ABSTRACT

Method and apparatus for providing an electronic commerce environment for leveraging orders from a plurality of customers. Specifically, the apparatus and method is designed to provide an electronic commerce environment for aggregating orders from a plurality of customers, where the savings associated with the winning bid for such large aggregate order are, in turn, awarded to the customers in accordance with the size of their respective orders.

This application claims the benefit of U.S. Provisional Application No. 60/191,938 filed on Mar. 24, 2000 which is herein incorporated by reference.

The present invention relates to an apparatus and concomitant method for providing an electronic commerce environment for leveraging orders from a plurality of customers. Specifically, a plurality of orders are aggregated and presented to a plurality of bidding vendors. The savings associated with the winning bid are, in turn, awarded to the customers in accordance with the size of their respective orders.

### BACKGROUND OF THE DISCLOSURE

The Business to Business electronic commerce known as “B2B” is a new and a vast enterprising vehicle conducted on the world wide web (WWW) between two or more companies to take advantage of the global nature, speed and productivity of the internet communication medium. These digital networks enhance immensely the effectiveness and efficiency of the supply chains of both manufacturers and suppliers. However, more recently, B2B has been expanding dramatically both in concept and applicability, to include a whole industry or a trade, buying, selling and dealing with one another online. This unprecedented change in the way business is being conducted has provided benefits to both customers and vendors. Utilizing the Internet, businesses can conduct complex, multitasked and multinodal transactions between customers and suppliers.

Today, there exist on the Internet two main bidding processes. The first and most common model is the online “open bidding” where a customer bids on a specific item or service against other interested bidders until he offers a price that no one else is willing to match or exceed. This is the model used by eBay, youBid.com, and several other websites. It is essentially an online auction model. ABDU/002

The second bidding process is called “inverse bidding” and is utilized for example by Priceline.com. In this model, customers have to be members of the Priceline.com club and carry a membership card. A customer starts by naming his or her price for a specific item or service, and Priceline.com tries to match by scanning its network of participating members of vendors and suppliers. If the customer's bid is accepted, the customer is informed to pick his item from the specific vendor/supplier identified to him by Priceline.com where he pays for the item directly at the supplier's register. If the price named by the customer was too low for Priceline.com to match, then it informs the customer that the offer was not accepted or the closest price available.

The deficiency of the above methods is that such models are inappropriate for business to business transactions. First, such models are designed for direct consumer consumption, because the vendors have a very limited supply of goods to offer. Such limited supply will not be sufficient for business transaction.

Second, the goods and services offered by such models are often under “distress”, i.e., the goods and services are very time sensitive. For example, the near term or immediate availability of airline seats and hotel rooms are perishable if these services are not consumed, i.e., unfilled seats and rooms are lost on a daily basis.

Third, the goods and services offered by such models are not aggregated for the benefits of the consumers, i.e., bids from consumers are not aggregated to give consumers the best price. Additionally, even if bids are aggregated, the total benefits are then equally distributed to all consumers without regard to the order volume of each consumer. One negative effect is that a customer with a large order may be adverse to joining such group purchase since it alone is generating substantially all the benefits for the other participants in the buying group, who may be competitors of the customer with the large order. Additionally, the customer with a large order may be adverse to placing its entire order with one site, and may decide to separate the order into separate smaller orders with different sites to ensure best pricing.

Thus, it would be very desirable to have an apparatus and method that is designed to provide an electronic commerce environment for leveraging orders from a plurality of customers, where the savings associated with the winning bid are, in turn, awarded to the customers in accordance with the size of their respective orders.

### SUMMARY OF THE INVENTION

In one embodiment of the present invention, a method and apparatus is disclosed that provides an electronic commerce environment for leveraging orders from a plurality of customers. Specifically, customer orders for a common product or service are aggregated into a single order by an independent transaction provider. In one embodiment, the independent transaction provider is an operator of a web site accessible via a set of global networks, i.e., the Internet. The aggregate order is then presented for bidding to a plurality of interested vendors by the independent transaction provider without disclosing information concerning the customers. Namely, the vendors simply view the aggregate order as a single order with a set of specified requirements.

Once a winning bid is selected, the savings associated with the bid are allocated in accordance with the volume of each customer. As such, a customer with a large volume will generally receive a greater cost saving than a customer with a smaller volume.

Additionally, the best vendor bid may be optionally refused based upon a threshold. Namely, the savings are evaluated to determine if they are sufficient for the customer(s) or the operator of the independent transaction provider to accept. Thus, a certain level of savings is maintained as an incentive to promote customer participation and loyalty.

### BRIEF DESCRIPTION OF THE DRAWINGS

The teachings of the present invention can be readily understood by considering the following detailed description in conjunction with the accompanying drawings, in which:

FIG. 1 depicts a block diagram of an overview of the architecture of the present invention for providing electronic commerce environment for leveraging orders from a plurality of customers over a local network or a global set of interconnected computer networks, i.e., the Internet or world wide web; and

FIG. 2 depicts a block diagram of a flowchart of the method of the present invention for providing electronic commerce environment for leveraging orders from a plurality of customers; and

FIG. 3 depicts an alternate block diagram of a flowchart of the method of the present invention for providing electronic commerce environment for leveraging orders from a plurality of customers.

To facilitate understanding, identical reference numerals have been used, where possible, to designate identical elements that are common to the figures.

### DETAILED DESCRIPTION

The present invention provides an electronic commerce environment that will allow business to business transactions to be efficiently conducted. Specifically, the electronic commerce environment, e.g., a web site, will enlist the membership of several manufacturers (i.e., customers) within an industry, to consolidate their demands and requirements from raw materials to intermediates and packing components as well as other services, and bid these to key vendors and service providers. An important aspect of the present invention is that the savings associated with the winning bid are, in turn, awarded to the customers in accordance with the size of their respective orders (herein known as “Online Volume Indexed Bidding” or OVIB). The system collates, online, the volumes of a specific item or service requested by several participating customers into a proprietary and confidential database. The total volume is then provided to key participating vendors and suppliers to bid on in real-time. The price reductions obtained from the winning bidder is passed back to the participating manufacturers according to a formula that is based on the volume ordered by each customer, as discussed below. Large orders will get certain premiums or savings higher than those with smaller orders, but every manufacturer will see a significant price reduction compared to its current ongoing price. At the same time, the leveraging of the total volumes ordered to one or a few vendors/suppliers will provide them with enormous benefit of scale. Because of the large volume demand, they will be able to increase the capacity utilization of their plants, conduct longer production runs and larger batches, thereby maximizing the efficiency of their supply chains. In fact, the volume driven incremental savings enjoyed by customers serve as a powerful incentive to offer their entire order at one site, thereby promoting customer loyalty. Thus, the present invention provides significant benefits to both buyers and sellers and assures a win-win transactional outcome.

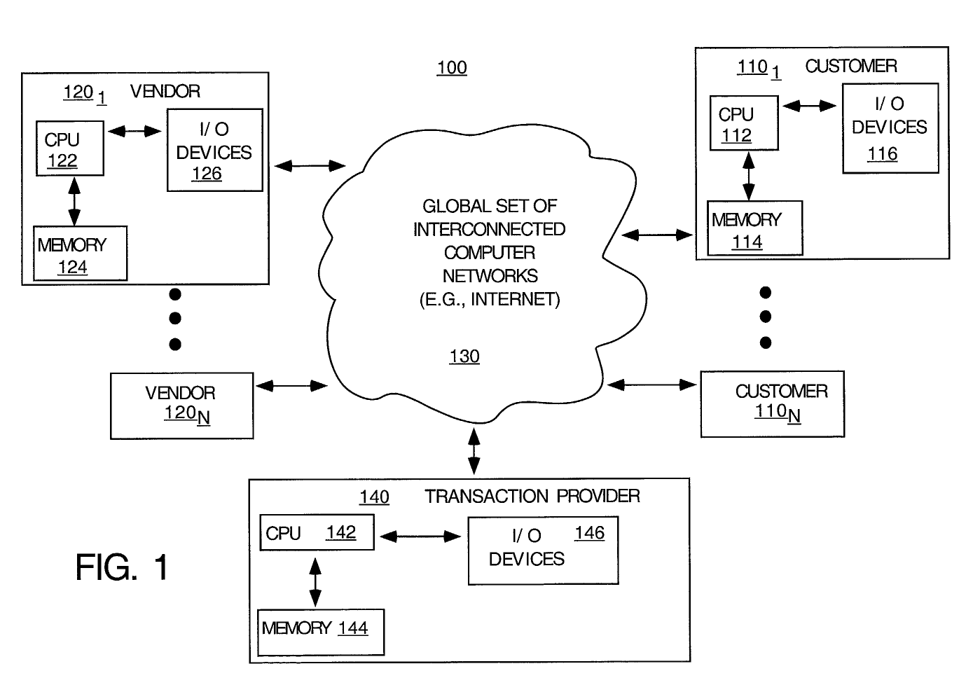

FIG. 1 depicts a block diagram of an overview of the architecture 100 of the present invention for providing electronic commerce environment for leveraging orders from a plurality of customers over a local network or a global set of interconnected computer networks, i.e., the Internet or World Wide Web. The Internet is a global set of interconnected computer networks communicating via a protocol known as the Transmission Control Protocol and Internet Protocol (TCP/IP). The World Wide Web (WWW) is a fully distributed system for sharing information that is based upon the Internet. Information shared via the WWW is typically in the form of HyperText Markup Language (HTML) or (XML) “pages” or documents. HTML pages, which are associated with particular WWW logical addresses, are communicated between WWW-compliant systems using the so-called HyperText Transport Protocol (HTTP). HTML pages may include information structures known as “hypertext” or “hypertext links.” Hypertext, within the context of the WWW, is typically a graphic or textual portion of a page which includes an address parameter contextually related to another HTML page. By accessing a hypertext link, a user of the WWW retrieves the HTML page associated with that hypertext link.

The architecture of FIG. 1 illustrates a plurality of customers 110₁₋ₙ, transaction provider 140 of the present invention, and a plurality of vendors 120₁₋ₙ, that are all connected via the Internet 130. As discussed below, the Online Volume Indexed Bidding method of the present invention can be implemented as a function that is operated within the transaction provider 140.

Specifically, each customer is an entity operating a general purpose computer or Personal digital assistant (PDA) or other Wireless Application Protocol controlled device having a central processing unit (CPU) 112, a memory 114, and various Input/Output (I/O) devices 116. The input and output devices 116 may comprise a keyboard, a mouse, a modem, a camera, a camcorder, a video monitor, any number of imaging devices or storage devices, including but not limited to, a tape drive, a floppy drive, a hard disk drive or a compact disk drive. The general purpose computer allows the customer to gain access to the services and information available on the Internet. Access to such services and products may include web sites operated by transaction provider 140 of the present invention.

In turn, each vendor is an entity operating a general purpose computer or Personal digital assistant (PDA) or other Wireless Application Protocol controlled device having a central processing unit (CPU) 122, a memory 124, and various Input/Output (I/O) devices 126. The input and output devices 126 may comprise a keyboard, a mouse, a modem, a camera, a camcorder, a video monitor, any number of imaging devices or storage devices, including but not limited to, a tape drive, a floppy drive, a hard disk drive or a compact disk drive. The general purpose computer allows the vendor to gain access to the services and information available on the Internet. Access to such services and products may include web sites operated by transaction provider 140 of the present invention.

Unfortunately, as discussed above, although the customers and vendors can interact directly with each other to effect online business to business transactions, such “individualized” transaction does not take advantage of the flexibility and efficiency provided by the Internet. Namely, each customer will interact directly with individual vendor, thereby failing to take advantage of the ability to leverage orders as a collective group of customers. Additionally, the customer is unable to disguise its identity at the point of presenting the order for bidding, which may affect the manner in which a vendor will bid on a particular order. For example, if a vendor is aware of the particular constraints of a particular customer, the vendor may not bid as aggressively, thereby resulting in a higher bid for the customer. More importantly, even if a group of customers are able to aggregate their orders, the benefits of such volume order are often divided equally, thereby reducing the incentive of the customer with the largest order to participate, since such customer will perceive other customers as riding on his coattail. Such sentiment is further amplified if the customers are also competitors in their field.

Additionally, the customer with the largest order will often take the position that it will be able to obtain some savings directly from the vendor anyway without having to aggregate its order with other customers who might actually be competitors. Such customer may be willing to forego some additional savings for the sake of not helping its competitors.

To address such deficiencies, the present invention provides a transaction provider 140 that provides an electronic commerce environment for leveraging orders from a plurality of customers. Specifically, a plurality of orders are aggregated and presented to a plurality of bidding vendors. The savings associated with the winning bid are, in turn, awarded to the customers in accordance with the size of their respective orders.

The transaction provider 140 is also implemented using a general purpose computer having a central processing unit (CPU) 142, a memory 144, and various Input/Output (I/O) devices 146. The input and output devices 146 may comprise a keyboard, a mouse, a modem, a camera, a camcorder, a video monitor, any number of imaging devices or storage devices, including but not limited to, a tape drive, a floppy drive, a hard disk drive or a compact disk drive. In the preferred embodiment, various functions of the transaction provider 140 as discussed below are implemented (in part or in whole) by a software application that is loaded from a storage device and resides in the memory 144 of the computer. As such, the transaction provider 140 and associated methods and/or data structures of the present invention can be stored on a computer readable medium. For example, the present Online Volume Indexed Bidding method and associated data structures can be stored on a computer readable medium. Finally, it should be noted that the general purpose computer of the transaction provider 140 should be broadly interpreted to include one or more personal computers, servers, main frames and the like.

Under this novel approach, several advantages can be realized. First, the identity of the customers can be kept in confidence to ensure aggressive bidding from the vendors. Without knowing the identities of the customers, the vendors must put forth their best bid. Additionally, because the operator of the electronic commerce environment is an independent entity that is not wholly owned by either the manufacturers (customers) or the vendors and suppliers, it can assure both entities of fair transactional terms. It also will eliminate any antitrust concerns. Another important privacy feature of the present business method is that the volume demands, market forecasts and schedules of deliveries, material specifications and standards, etc., would be kept only by the operator of the electronic commerce environment. This will guarantee the confidentiality of all technical and business information for each member company, if the customers desire to keep such information confidential.

Second, the volume based savings method encourages customers with the largest orders to participate, without feeling that their large orders will be used to provide advantages to their competitors. Namely, all customers will still receive savings, but such savings will not be awarded equally. The customer with the largest order will still get the most savings, thereby alleviating the feeling that it helped its competitors through its sizable order.

Third, the independent transaction provider 140 will ensure the best objective pricing, since the independent transaction provider 140 derives revenues predominately from membership fees, commission earned on each transaction and advertising. Namely, as the volume rises, savings will rise accordingly without the fear that such savings will simply be siphoned off by the independent transaction provider 140.

Fourth, since the savings are volume based, the customer is encouraged to place their entire order to maximize the greatest benefit, which, in turn, promotes customer and vendor loyalty in the long run. Namely, as customers realize significant savings, it will feel more confident in placing large orders through the independent transaction provider 140. Similarly, vendors will feel more confident in receiving large orders through the independent transaction provider 140 at the expense of offering a lower bid to receive a steady stream of sizable orders. Thus, both customers and vendors will derive substantial benefits from the services provided by the independent transaction provider 140 of the present invention.

Fifth, due to the large volumes obtained by the operator of the electronic commerce environment through the consolidation of demands from different companies and the variable delivery schedules for each company, the operator of the electronic commerce environment will be uniquely positioned to take advantage of the “law of averaging”, where inevitably some participating buyers will increase or accelerate their demands, while others will decrease or decelerate theirs. This could possibly result in a small, even negligible net effect in the overall demand and thereby avoiding major disruptions in the vendors' ability to react to customers' changing needs, and as a result, avoiding major shortages or excess inventories depending on the changing forecasts from the customers.

Both customers and suppliers will be in a better position to optimize their inventory levels because of the flexibility inherent in the B2B system due to the inevitability of various changes in the individual company's forecasts either up or down. Lower inventory levels will enable member companies to reduce cost of money and enhance earnings.

Sixth, the consolidated large volumes, and the stability of the overall averaged forecast of a specific item or service will allow efficient, more productive vendors and suppliers to grow and attract more capital investments, which, in turn, will enhance their reliability and strengthen the suppliers' overall network. This is a great benefit to the manufacturers (customers) where the viability and dependability of their vendors' and suppliers' network are a major concern today.

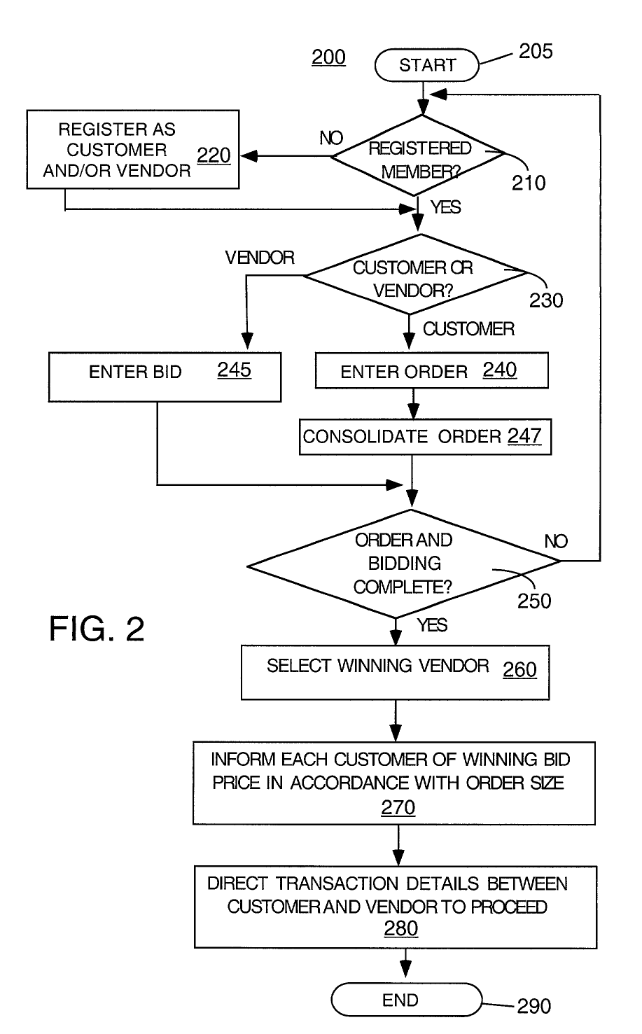

FIG. 2 depicts a block diagram of a flowchart of the method 200 of the present invention for providing electronic commerce environment for leveraging orders from a plurality of customers. Method 200 starts in step 205 and proceeds to step 210.

In step 210, method 200 queries whether a user who is accessing the transaction provider 140 of the present invention is a registered member. If the query is answered positively, method 200 proceeds to step 230. If the query is answered negatively, method 200 proceeds to step 220, where the user is registered as a customer and/or vendor. Namely, the user is requested to provide various information including but not limited to: name, company, address, phone number, email address, product name, quantity, units, specification, size of order, form of delivery, delivery time frame, method of payment and the like. It should be noted that the user can be registered as both customers and vendors, since it may be a customer in one capacity and it may be a vendor in another capacity.

In step 230, method 200 queries whether the registered user is a customer or a vendor. If the registered user is a customer, then method 200 proceeds to step 240, where the customer will enter an order for a product or service. The order may comprise the following information: material, specifications, current vendor, other approved vendors, other available vendors, annual quantity ordered, duration of current contract, comments, and the like. Alternatively, the customer may be presented with a list of currently “active” or “available” list of goods and services that the customer can join in purchasing. For example, if the customer sees that an order of power supplies has been placed, but has not officially been presented for bidding, then the customer may join its own purchase order of such power supplies by providing pertinent purchase information to the system of the transaction provider 140. In turn, the system will aggregate this new order with any existing orders for the same products and/or services in step 427.

If the registered user is a vendor, then method 200 proceeds to step 245, where the vendor will enter a bid for filling an order for products or services that the vendor is capable of filling. The bid may comprise the following information: units, capacity (e.g., monthly, quarterly, annually), status of regulatory approvals (e.g., FDA, MCA, etc.), specification, (e.g., NF, USP, BP, EP, etc.), manufacturing sites, shipping sites, mode of ordering, size and form of shipped product and the like. Alternatively, the vendor may be presented with a list of currently “active” or “available” list of goods and services that are being requested to be filled. For example, if the vendor sees that an order for power supplies has been requested, but bidding has not officially ended, then the vendor may join by providing pertinent bid information to the system of the transaction provider 140.

In step 250, method 200 queries whether an order process or bidding process is completed. Namely, both order and bidding process may be designed with a window of time in which the order or bidding will be in progress. For example, customers are given a week to join in a purchase or vendors are given a week to provide a bid or alter an existing bid. Once the allotted time has expired, the order or bidding process is deemed to be completed. If the query is negatively answered, then method 200 returns to step 210 pending additional customers or vendors to join the transaction. If the query is positively answered, then method 200 proceeds to step 260 where a winning vendor is selected. The system will select the best bid for the same products and/or services. The winning bid will be selected based upon various criteria, e.g., price, delivery schedule, reputation on quality, regulatory approval status, and/or any other specified requirements listed by the customer(s).

In step 270, method 200 informs each customer who has joined in the purchase order the winning bid in accordance with their respective order size. Namely, the benefit of the aggregated purchase order is presented differently to each customer based upon their respective volume. Each customer will only be able to see its own purchase price. For example, a large volume customer may be presented with a unit price of $0.50 per unit, whereas a small volume customer may be presented with a unit price of $0.55 per unit for the same requested product in the aggregate order. One example of the novel formulation for the assignment of the savings in accordance to volume is provided below.

In step 280, method 200 may optionally organize the transaction details between the winning vendor and the customers. Such transaction details may include but are not limited to: payment method, shipping schedules, mode and form of shipping, purchase of insurance and the like. Alternatively, once the customer is informed of the winning vendor, the transaction provider 140 may simply provide the necessary information to allow the customer and vendor to consummate the transaction with the agreed terms under the winning bid. Method 200 then ends in step 290.

The revenues to the operator of the electronic commerce environment (transaction provider) is expected to come from three different sources. The first is from the recurring subscription (membership) and maintenance fees from the participants in the business transaction networks. These include both customers (manufacturers) and suppliers and service providers. The second and most important source of revenues will be from the commission charged on each transaction, normally from the vendor or supplier. Finally, the third source of revenue is expected to come from advertising on the operator of the electronic commerce environment's web site which will be extremely busy with buyers and sellers conducting what could possibly be multibillion-dollar transactions. Further unprecedented opportunities for growth are expected to continue as more manufacturers and suppliers and service providers join as new participants in the novel B2B transaction environment offered by the transaction provider.

### EXAMPLE OF THE TRANSACTION PROVIDER SERVICING THE PHARMACEUTICAL INDUSTRY

One embodiment of the present invention is to apply the business method discussed above to the pharmaceutical industry, but this invention is not so limited and can be expanded to other industries, e.g., chemicals, electronics, etc. The pharmaceutical industry was selected because of its large size, and its particular amenability to the B2B approach.

The pharmaceutical industry is generally fragmented and in spite of the most recently announced mergers and acquisitions, no company is expected to have more than 7-9% market share. The suppliers and vendors to the pharmaceutical industry are particularly fragmented and will lend itself to the novel B2B approach of the present invention.

For example, the operator of the electronic commerce environment has the opportunity to receive from the member manufacturing companies (customers) and to consolidate online their volume demands and schedules of deliveries of a specific raw material, an intermediate, a packaging component, a laboratory supply need or a specific common technical or operating service. This enables the vendors and suppliers to bid on an unprecedented large scale of products which will allow them to offer significant price reductions that will be passed to the customers. Utilizing the present OVIB system, the price reduction will be indexed to the volume ordered, thereby allowing a fair advantage to each customer according to the size of his order, but guaranteeing that every customer will benefit significantly compared to the current system where everyone orders individually, and negotiates the price on an arbitrary and subjective basis. Smaller customers will be able to get reductions that they cannot get based on their volumes alone, while large customers can get even more reductions than what they are receiving today. This will greatly enhance the gross margin and earnings growth for all customers.

Additionally, greater efficiency will be gained by manufacturing larger batches and conducting longer production runs that will minimize the costly need for change-overs and high quality control expenses. Consolidating large volumes from different manufacturers with a possible long term commitment will enable the vendors and suppliers to attract capital investment in the upgrading and expansion of their facilities. This will improve their gross margins and enhance earnings.

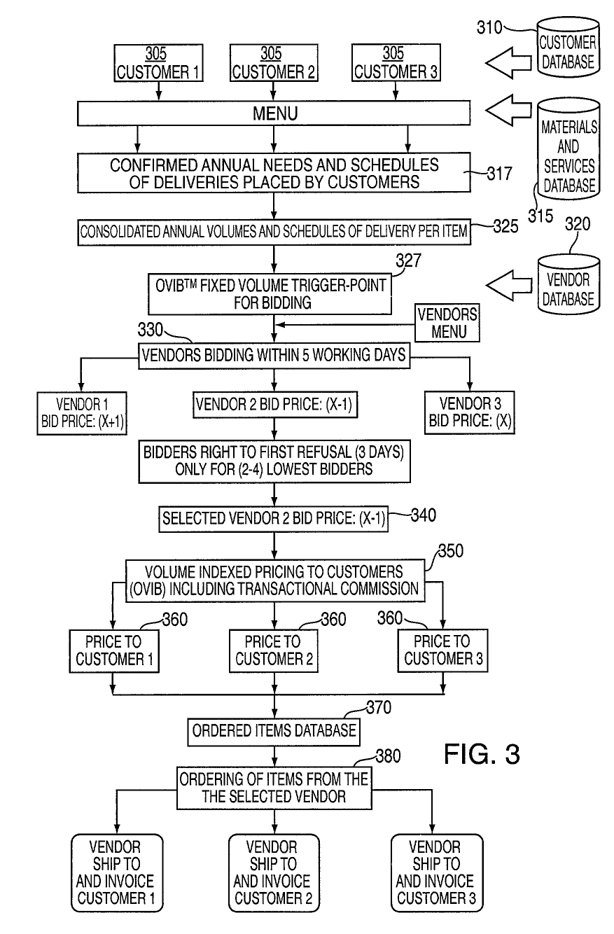

The unique features of the OVIB system deployed for the pharmaceutical industry is illustrated in FIG. 3 and can be summarized as follows:

Step 1. A pharmaceutical and/or a chemical manufacturing company membership group is established for a nominal fee paid by each member 305 for its participation and for system maintenance and constant update. This will constitute the “Customer” database 310.

Step 2. A vendor/supplier group (to the pharmaceutical and chemical companies) is established, also for a nominal fee paid by each member for its participation and for system maintenance and upgrade. This will constitute the “vendors and suppliers” database 320.

Step 3. A database is created consisting of all the items and services available from the participating vendors and suppliers and their capacity to deliver on an annual, quarterly and/or monthly basis. This will constitute the “materials and services” database 315.

Step 4. Each customer is requested to enter its normal annual demand and the monthly schedule of delivery for each item or service that he intends to purchase into a proprietary database in step 317.

Step 5. A software application is used in step 325 to add up in real time the total annual and monthly demands per item or service. This information will enable the operator of the electronic commerce environment to keep a confidential and proprietary list of the total demand volumes of all participating customers in one database which is only accessible to the operator of the electronic commerce environment. A triggering point in step 327 (e.g., volume based, time based, etc.) is predefined and is used as a triggering point for presenting the aggregate order for bidding.

Step 6. The interactive software application will provide the vendors' and suppliers' member list with the total demand of each item or service they are interested to bid on in step 330. There will be a predefined period, e.g., approximately five working days, for the bids to be entered by the vendors and suppliers.

Step 7. The software application will enable the operator of the electronic commerce environment to select the best price offer in step 340, and to automatically index this price to the volumes ordered by each member customer according to a mathematical algorithm in step 350 that may vary according to the type of material or service provided (See below).

Step 8. The customer will be informed of the vendor or supplier with the best offered price in step 360 and will be asked to place an order with the operator of the electronic commerce environment for that specific item or service with the required schedule of delivery in step 370. Alternatively, the customer may be asked to place the order directly with the winning vendor with the agreed terms of the winning bid.

Step 9. The operator of the electronic commerce environment may optionally help to arrange for the physical shipment and delivery of the item or service from the vendor or supplier to the customer without actually taking title for the goods or maintaining any physical inventories as the vendor or supplier will invoice the customer directly in step 380. Financial transactions could be conducted in real time and on line, between the vendor/supplier and the customer.

Step 10. The operator of the electronic commerce environment gets an agreed upon commission from the vendor or supplier based on the dollar value of the transaction.

Contrary to the bidding processes available today on the internet, the OVIB system incorporates a mathematical algorithm that helps index the price offered for each item or service purchased on the internet to the volume ordered of that specific item or service. Therefore, while every customer gets a significant price reduction as a result of the leveraging of the total volumes of individual companies participating in the system, larger orders will get a larger price benefit, while smaller orders will still be able to get significant price reduction which they could not have obtained alone. The present business method is unique and is tailored to B2B transactions.

The operator of the electronic commerce environment will be the sole holder of the total volume lists per item or service which will be updated in real time and will be provided to appropriate vendors and suppliers to bid on. The confidentiality of each customer needs and forecasts will be guaranteed by the operator of the electronic commerce environment.

On Line Volume Indexed Bidding (OVIB) Method

The OVIB method will provide a significant discount to the large volume buyers, while still supplying a reasonable discount to the small and medium buyers. In addition, the formula will also reject those transactions where the price savings do not justify the overall transaction for the large volume companies.

The algorithm is as follows:

Defined Terms

LV=Large Company Order Volume in units

MV=Medium Company Order Volume in units

SV=Small Company Order Volume in units

AV=Average Order Volume in units

TV=Total Order Volume in units

TVB=Sum of all Order Volumes that are less than or equal to the AV

LP=Large Company Price obtainable outside of aggregate order

MP=Medium Company Price obtainable outside of aggregate order

SP=Small Company Price obtainable outside of aggregate order

NP=Negotiated Price from Vendor for aggregate order per unit

CLP=Calculated Large Company Price per unit based on aggregated volume

CMP=Calculated Medium Company Price per unit based on aggregated volume

CSP=Calculated Small Company Price per unit based on aggregated volume

CLP′=Adjusted Calculated Large Company Price

CMP′=Adjusted Calculated Medium Company Price

CSP′=Adjusted Calculated Small Company Price

TC=Total Cost in units=NP*TV

Portion A=A base portion (e.g., a first portion) of the winning bid (e.g., 95% to 100%)

Portion B=A second portion of the winning bid (e.g., 0% to 5%)

X=Saving in percentage for a Large Company

Y=Saving in percentage for a Medium Company

Z=Saving in percentage for a Small Company

It should be noted that the percentages for the variables “Portion A”, “Portion B”, “X”, “T” and “Z” can be selectively modified according to the specific material that is transacted or other requirements. Similarly, the number of customer types, e.g., Large, Medium and Small Company Order Volumes, can be adapted and adjusted to a particular application as required.

Preferred Solution

Solve for Maximum Discount Where All Rules Hold True

Rules

1. CLP is at least X% less than LP

2. CMP & CSP are at least Y% and Z% less than MP and SP respectively

3. Portion A+Portion B=100%

Specifically, the present invention provides a threshold(s) that must be satisfied before a bid is considered viable for a particular customer. For example, each customer or the operator of the transaction provider may require a certain amount of savings to be obtained before committing to a bid offered to the transaction provider 140. For example, if the savings to a customer with a large volume is very negligible, then the customer may not be inclined to buy from a new vendor in view of the meager savings and the added risk in dealing with a new vendor. Such unsatisfactory experience may discourage customer loyalty and participation in the long run. Thus, the variables X and Y are set to reasonable percentages to ensure significant savings before a winning bid is accepted by the transaction provider 140. Thus, the present invention is able to apply the threshold(s) to determine if a winning bid should be awarded to a vendor.

The present invention also has the ability to drop or “un-aggregate” a customer order from the aggregate order if the desired savings of a particular customer is unrealistic or unattainable (e.g., in the scenario where customers are allowed to set or affect the percentages of X and Y). Namely, by dropping one customer, the requirements of the remaining customers may still be met by a winning bid.

Calculation

1. Part A—All Share Pro Rata Based on Volume Levels

CLP=LV/TV*Portion A*TC (1)

CMP=MV/TV*Portion A*TC (2)

CSP=SV/TV*Portion A*TC (3)

2. Part B—Volume Levels that are Less than the Average Volume Must Share Pro Rata In The Cost Attributed To Portion B

If LV>AV, then no adjustment to CLP in equation (1); else CLP′=CLP+LV/TVB*Portion B*TC (4)

If MV>AV, then no adjustment to CMP in equation (2); else CMP′=CMP+MV/TVB*Portion B*TC (5)

If SV>AV, then no adjustment to CSP in equation (3); else CSP′=CSP+SV/TVB*Portion B*TC (6)

3. Part A+Part B=Total $ Cost for Order

Namely, the present invention ensures that after the allocation of respective bid prices to all the customers based on their respective volume, the total cost of the winning bid is maintained.

To better understand the OVIB method of the present invention, an example is now presented.

Assume the following:

LV=7 units

MV=2 units

SV=1 unit

TV=10 units

NP=$1.00/unit

TC=$10.00

LP=$1.10/unit

MP=$1.30/unit

SP=$1.35/unit

X≧5%

Y≧5%

Z≧5%

Portion A=95%

Portion B=5%

The calculations for CLP, CMP and CSP in accordance with equations (1) to (3) in Part A above are as follow:

$$CLP = 7 / 10 * 0.95 * \$1 .00 * 10 = \$6 .65 for 7 units$$

$$CMP = 2 / 10 * 0.95 * \$1 .00 * 10 = \$1 .90 for 2 units$$

$$CSP = 1 / 10 * 0.95 * \$1 .00 * 10 = \$0 .95 for 1 unit$$

$$Total : = \$9 .50$$

It should be noted that the cost for each unit ($0.95) is identical for all three customers, initially. Namely, the variable “Portion A” defines a base portion in which the calculated unit cost for this base portion will be the best possible unit price. This cost is preliminarily assigned to CLP, CMP and CSP unless modified below in Part B of the calculation.

The adjustments to CLP, CMP and CSP in accordance with equations (4) to (6) in Part B above are as follow:

CLP′=CLP, since LV (7) is greater than AV(3⅓)

CMP′=CMP+((2/3)*0.05*$1.00*10)=$1.90+$0.333=$2.233 for 2 units

CSP′=CSP+((1/3)*0.05*$1.00*10)=$0.95+$0.167=$1.117 for 1 unit

It should be noted that in this example, TVB is the sum of only the MV and SV, since LV is greater than the AV. Furthermore, the example illustrates that the unit cost for the customer with the LV is only $0.95 versus $1.117 for both the customer with the Mv and the customer with the SV. Additionally, since both rules (1) and (2) above for variables X and Y are also satisfied, the bid of $1.00/unit will be accepted by the transaction provider 140.

Furthermore, it should be noted that the customers with the Mv and SV share a common price per unit. The present invention is not so limited. Namely, it is possible that several customers with slightly different volume sizes will still share a common price, since their differences in volume size are negligible.

Although various embodiments which incorporate the teachings of the present invention have been shown and described in detail herein, those skilled in the art can readily devise many other varied embodiments that still incorporate these teachings.

What is claimed is:

1. A method for providing a transaction environment, said method comprising the steps of:
a) receiving a first order from a first customer for a product or service at a first volume;
b) receiving a second order from a second customer for said product or service at a second volume;
c) offering said first order and said second order as an aggregate order for bidding to at least one vendor;
d) selecting a winning bid from said at least one vendor; and
e) allocating said winning bid in accordance with said first and second volume.

2. The method of claim 1, wherein said winning bid is separated in a first portion and a second portion, wherein said winning bid is allocated differently between said first and second portions.

3. The method of claim 2, wherein said winning bid is allocated uniformly for said first and second customers in said first portion and wherein said winning bid is allocated non-uniformly for said first and second customers in said second portion.

4. The method of claim 2, wherein said first portion comprises approximately ninety-five percent to one hundred percent of said winning bid, and said second portion comprises approximately zero percent to five percent of said winning bid.

5. The method of claim 2, wherein said allocating step (e) allocates in accordance with:
CLP=LV/TV*Portion A*TC
CSP=SV/TV*Portion A*TC
where CLP is a calculated price for said first customer having a large volume, where CSP is a calculated price for said second customer having a small volume, where LV is said large volume, where SV is said small volume, where TV is a total volume, where portion A is said first portion and where TC is said winning bid.

6. The method of claim 5, wherein said CLP and said CSP are adjusted in accordance with:
If LV>AV, then no adjustment to CLP; else CLP′=CLP+LV/TVB*Portion B*TC;
If SV>AV, then no adjustment to CSP; else CSP′=CSP+SV/TVB*Portion B*TC;
where said AV is an average volume, where said portion B is said second portion, and where TVB is a sum of all of said order volumes that are less than said AV.

7. The method of claim 1, further comprising the step of:
(d′) verifying said winning bid from said at least one vendor with a savings threshold, where if said savings threshold is satisfied, then allocating step (e) is performed.

8. The method of claim 1, wherein said method for providing a transaction environment is applied to a pharmaceutical industry.

9. The method of claim 1, wherein said method for providing a transaction environment is applied to a chemical industry.

10. The method of claim 1, further comprising the step of:
(f) awarding a commission to an operator of said transaction environment in accordance with said winning bid.

11. The method of claim 1, wherein said transaction environment is deployed over a global network of computer networks.

12. A computer-readable medium having stored thereon a plurality of instructions, the plurality of instructions including instructions which, when executed by a processor, cause the processor to perform the steps comprising of:
a) receiving a first order from a first customer for a product or service at a first volume;
b) receiving a second order from a second customer for said product or service at a second volume;
c) offering said first order and said second order as an aggregate order for bidding to at least one vendor;
d) selecting a winning bid from said at least one vendor; and
e) allocating said winning bid in accordance with said first and second volume.

13. The computer-readable medium of claim 12, wherein said winning bid is separated in a first portion and a second portion, wherein said winning bid is allocated differently between said first and second portions.

14. The computer-readable medium of claim 13, wherein said winning bid is allocated uniformly for said first and second customers in said first portion and wherein said winning bid is allocated non-uniformly for said first and second customers in said second portion.

15. The computer-readable medium of claim 13, wherein said first portion comprises approximately ninety-five percent to one hundred percent of said winning bid, and said second portion comprises approximately zero percent to five percent of said winning bid.

16. The computer-readable medium of claim 13, wherein said allocating step (e) allocates in accordance with:
CLP=LV/TV*Portion A*TC
CSP=SV/TV*Portion A*TC
where CLP is a calculated price for said first customer having a large volume, where CSP is a calculated price for said second customer having a small volume, where LV is said large volume, where SV is said small volume, where TV is a total volume, where portion A is said first portion and where TC is said winning bid.

17. The computer-readable medium of claim 16, wherein said CLP and said CSP are adjusted in accordance with:
If LV>AV, then no adjustment to CLP; else CLP′=CLP+LV/TVB*Portion B*TC;
If SV>AV, then no adjustment to CSP; else CSP′=CSP+SV/TVB*Portion B*TC;
where said AV is an average volume, where said portion B is said second portion, and where TVB is a sum of all of said order volumes that are less than said AV.

18. The computer-readable medium of claim 12, further comprising the step of:
(d′) verifying said winning bid from said at least one vendor with a savings threshold, where if said savings threshold is satisfied, then allocating step (e) is performed.

19. The computer-readable medium of claim 12, further comprising the step of:
(f) awarding a commission to an operator of said transaction environment in accordance with said winning bid.

20. An apparatus for providing a transaction environment, said apparatus comprising:
means for receiving a first order from a first customer for a product or service at a first volume and for receiving a second order from a second customer for said product or service at a second volume;
means for offering said first order and said second order as an aggregate order for bidding to at least one vendor;
means for selecting a winning bid from said at least one vendor; and
means for allocating said winning bid in accordance with said first and second volume.

21. The apparatus of claim 20, wherein said winning bid is separated in a first portion and a second portion, wherein said winning bid is allocated differently between said first and second portions.

22. The apparatus of claim 21, wherein said winning bid is allocated uniformly for said first and second customers in said first portion and wherein said winning bid is allocated non-uniformly for said first and second customers in said second portion.

23. The apparatus of claim 21, wherein said first portion comprises approximately ninety-five percent to one hundred percent of said winning bid, and said second portion comprises approximately zero percent to five percent of said winning bid.

24. The apparatus of claim 21, wherein said allocating means allocates in accordance with:
CLP=LV/TV*Portion A*TC
CSP=SV/TV*Portion A*TC
where CLP is a calculated price for said first customer having a large volume, where CSP is a calculated price for said second customer having a small volume, where LV is said large volume, where SV is said small volume, where TV is a total volume, where portion A is said first portion and where TC is said winning bid.

25. The apparatus of claim 24, wherein said CLP and said CSP are adjusted in accordance with:
If LV>AV, then no adjustment to CLP; else CLP′=CLP+LV/TVB*Portion B*TC;
If SV>AV, then no adjustment to CSP; else CSP′=CSP+SV/TVB*Portion B*TC;
where said AV is an average volume, where said portion B is said second portion, and where TVB is a sum of all of said order volumes that are less than said AV.

26. The apparatus of claim 20, further comprising means for verifying said winning bid from said at least one vendor with a savings threshold, where if said savings threshold is satisfied, then said winning bid is allocated.

27. The apparatus of claim 20, further comprising means for awarding a commission to an operator of said transaction environment in accordance with said winning bid.

28. The apparatus of claim 20, wherein said apparatus comprises a web site for interacting with a global network of computer networks.
